(19) United States
(12) Patent Application Publication
(10) Pub. No.: US 2007/0003057 A1
(43) Pub. Date: Jan. 4, 2007

(54) Method of bit stream processing

(75) Inventors: Aweke Negash Lemma, Eindhoven (NL); Minne Van Der Veen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,931

(22) PCT Filed: Jan. 13, 2005
(86) PCT No.: PCT/IB05/50155

§ 371 Date: Jun. 29, 2006

(30) Foreign Application Priority Data
Jan. 16, 2004 (EP) 04100133.0

(51) Int. Cl. H04N 7/167; H04L 9/00; G06K 9/00

(52) U.S. Cl. 380/200; 713/176; 382/100

(57) ABSTRACT

The invention concerns a method of bit stream watermarking in a tandem coding system (300). The method involves arranging for the system (300) to comprise a series of stages including a first quantizing unit for processing an input signal to generate a first intermediate signal, a combining unit for embedding a watermarking signal into the intermediate signal to generate a second intermediate signal, and a second quantizing unit for processing the second intermediate signal to generate a watermarked output signal. The first quantizing unit to arranged to include a unit for predicting distortions arising in subsequent stages of the system (300) and generating one or more corresponding quantization noise reduction parameters. Moreover, the system (300) is operable to apply the one or more reduction parameters in at least one of the subsequent stages for reducing noise and/or distortion arising within the system (300).

### FIELD OF THE INVENTION

The present invention relates to methods of bit stream processing; in particular, but not exclusively, the invention concerns a method of bit stream processing when tandem coding is employed, for example bit steam watermarking when tandem coding is utilized. Moreover, the present invention also relates to apparatus arranged to implement the method.

### BACKGROUND TO THE INVENTION

Processing of data content is generally known. Such processing includes one or more of encoding, decoding, encrypting, decrypting, reformatting to mention just a few examples. Moreover, such processing can be beneficially implemented in some cases by employing tandem encoding-decoding apparatus which will be elucidated in more detail later.

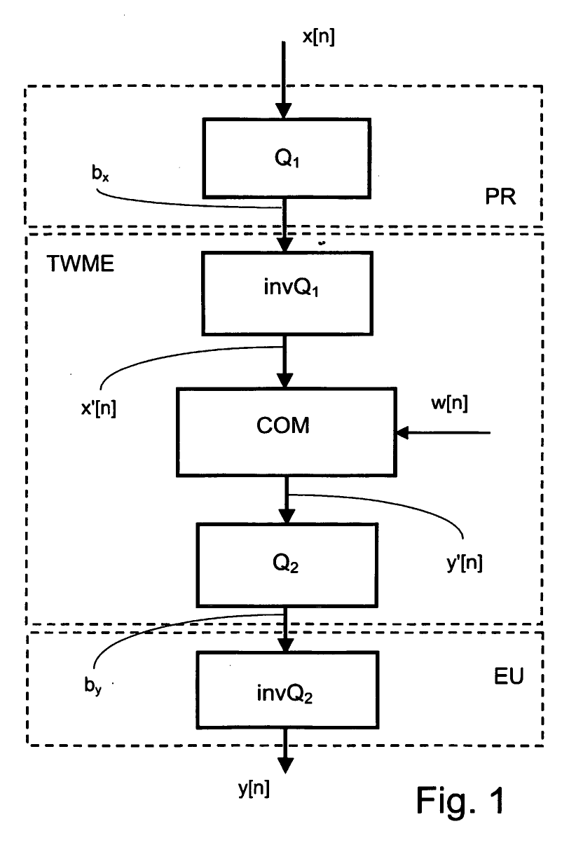

In particular, watermarking of data content is known, for example to try to prevent unauthorised copying and distribution of audio data content. To be effective, such watermarking needs to be reliably detectable and yet not degrade the quality of the data content perceptibly when watermarked. In FIG. 1, there is shown a schematic diagram of signal processing stages implemented in a known contemporary watermarking apparatus; the apparatus is arranged in a tandem configuration as will be described in more detail later.

The stages include a pre-coding stage (PR), and a transcoding watermark embedding stage (TWME). Associated with these two stages is an end-user stage (EU) where a user decodes encoded watermarked data content b_{y} to regenerate the data content y[n] for final consumption, for example video and/or audio programme material. In the precoding stage PR, an input signal x[n] is compressed by a first quantizer Q₁ to generate a compressed bit-stream bₓ. Moreover, in the watermark embedding stage TWME, the bit-stream bₓ is partially decoded by passing it through a dequantizer invQ₁ to generate a partially decoded bit-stream x′[n]. The embedding stage TWME also includes a combiner (COM) which is operable to combine the partially decoded bit-stream x′[n] with a watermark signal w[n] to generate a corresponding watermarked intermediate signal y′[n]. In sequence after the combiner COM, the embedding stage TWME also includes a second quantizer Q₂ which is arranged to receive the intermediate signal y′[n] from the combiner COM and generate the watermarked data content by. At the end-user stage EU, there is included a decoder invQ₂ for receiving the watermarked data content b_{y} to generate the data content y[n]. The watermarked data content by is susceptible to being conveyed to the user (EU) by way of a communication network, for example the Internet, or by way of a data carrier such as an optically-readable memory disc.

As a result of the combiner COM, the signal y′[n] is dissimilar to the input signal x′[n]. The combiner COM is designed to contribute as little distortion as possible so that y′[n] and x′[n] are substantially indistinguishable. The inventor has appreciated that the stages illustrated in FIG. 1 are also susceptible to introducing additional distortion as a consequence of tandeming, namely cascading, the two quantizers Q₁, Q₂. However, the inventor has also identified that such additional distortion due to tandeming does not substantially arise when the quantizers Q₁, Q₂ are similar. However, in most implementations of the stages in FIG. 1, for example in electronic music delivery (EMD) systems, tandeming distortions are encountered.

Such distortion can be affected by employing higher bit-rates at the first quantizer Q₁, for example in a manner of oversampling. When the pre-coding bit rate in the first quantizer Q₁ is dissimilar to that of the second quantizer Q₂, the quantizers Q₁, Q₂ behave independently resulting in extra noise being introduced in comparison to a situation where only the second quantizer Q₂ is employed.

Moreover, such distortions can also be affected when identical bit-rates are utilized at the first quantize Q₁ and the decoder invQ₂ at the user end EU. For example, in audio coding systems, a so-called psycho-acoustic model is computed from the input signal x[n]. As a consequence of subsequent signal processing in the combiner COM and the first quantizer Q₁, the signal y′[n] input to the second quantizer Q₂ is generally different from the input signal x[n] provided to the first quantizer Q₁. Consequently, scale factors of the quantizers Q₁, Q₂ are generally different which are susceptible to giving rise to additional quantization noise.

Thus, in contemporary bit stream watermarking systems, for example the aforesaid electronic music delivery (EMD) systems, tandeming problems are encountered. In these systems, audio data content corresponding to the bit-stream bₓ is stored in some compressed format, for example as AAC, MP3 or similar, after which it is at least partially decoded and then embedded with watermark data. The at least partial re-encoding of the watermarked data content often degrades audio signal quality more than would be expected merely as a consequence of including watermarking data alone. In order to reduce such degradation to ensure that audio is delivered at a desired quality, the inventor has envisaged that it is desirable to use bit rates for pre-encoded signals, namely for the signal bₓ, that are higher than the bit-rates utilized for the watermarked signal b_{y}. Although signal quality can be enhanced by such a selection of bit-rates, additional storage capacity is required which can be prohibitively costly.

Approaches to reducing distortion introduced into encoded signals subject to signal processing such as watermarking have been previously published. For example in an international PCT application no. PCT/EP00/09771 (WO 01/26262), there is described a method in which a data stream is initially processed to obtain spectral values for the short-term spectrum of an audio signal. Additionally, information to be introduced into the data stream relating to spectral values representing a short-term spectrum of the audio signal is subjected to a spread sequence for obtaining an expanded information signal leading to the creation of a spectral representation of the expanded information signal including scale factor information. This representation is then weighted using a determined psychoacoustic noise energy which can be masked to generate a weighted information signal in which the energy level of the introduced information is substantially equal to or lies below the psychoacoustic masking threshold. The information signal and the spectral values for the short-term spectrum are subsequently totalled and then re-processed to obtain a processed data stream comprising both the audio information and the information to be introduced. In order for the information to be introduced without having to pass into the time domain, the block raster which underlies the short-term spectrum is not infringed, so that the introduction of a watermark leads to a reduced tandem distortion effect. However, the method does not allow for substantial suppression of tandem effects but merely a reduction in their relative magnitude on account of appropriately using scale factor information. In contradistinction, the present invention potentially allows for substantially suppressing tandem effects entirely.

### SUMMARY OF THE INVENTION

An object of the invention is to provide an improved method of bit stream processing, for example watermarking, when tandem coding is employed, the method being operable to reduce distortion caused by quantization errors arising when undertaking such processing.

According to a first aspect of the present invention, there is provided a method of bit stream processing in a tandem coding system, the method including steps of:
(a) arranging for the system to comprise a series of stages including first quantizing means for processing an input signal to generate an intermediate signal, and second quantizing means for processing the intermediate signal to generate a processed output signal;
(b) arranging for the first quantizing means to include means for predicting distortions arising in subsequent stages of the system and generating one or more corresponding quantization noise reduction parameters; and
(c) applying said one or more noise reduction parameters in at least one of the subsequent stages for reducing noise and/or distortion arising within the system.

The invention is of advantage in that use of the reduction signal is capable of enhancing noise performance of the system.

Preferably, in the method, the one or more noise reduction parameters are derived using a cost function applicable to determine when overall quantization noise is minimized. Such derivation of the one or more parameters is beneficial in ensuring that the system automatically adjusts itself to exhibit lower noise and/or distortion.

Preferably, in the method, the system includes combining means arranged to embed a watermarking signal into the intermediate signal so that the processed output signal is a watermarked output signal.

Preferably, the method further comprises a step of arranging for the first quantizing means to derive one or more parameters for controlling the combining means for reducing quantization noise arising thereat in operation. By using such an arrangement, the combining means is capable of providing synergistic benefits of, for example, adding watermarking information whilst simultaneously providing noise reduction. More preferably, the one or more parameters are derived using a cost function applicable to determine when overall quantization noise is minimized.

Preferably, in the method, the combining means is arranged to at least partially decode the intermediate signal and then embed the watermarking signal therein. One benefit of insertion of watermark content in partially decoded signals that are subsequently re-encoded is that it is susceptible to rendering watermark information less immediately evident to counterfeiters and therefore potential assists to deter unauthorised copying of the output signal, for example when conveyed by way of a data carrier as digital data content.

Preferably, in the method, at least one of the one or more noise reduction parameters corresponds to a transcoding quantization error determined from a difference between:
(a) quantization noise arising in the second quantizing means; and
(b) a difference in quantization noise generated by a tandem combination of the first and second quantizing means.
   Such a manner of generating the one or more reduction parameters is found by the inventors to provide more favourable noise reduction.

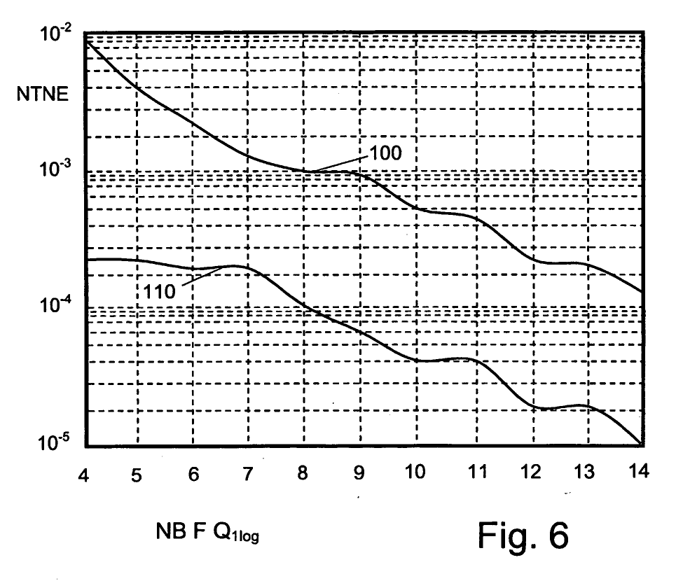

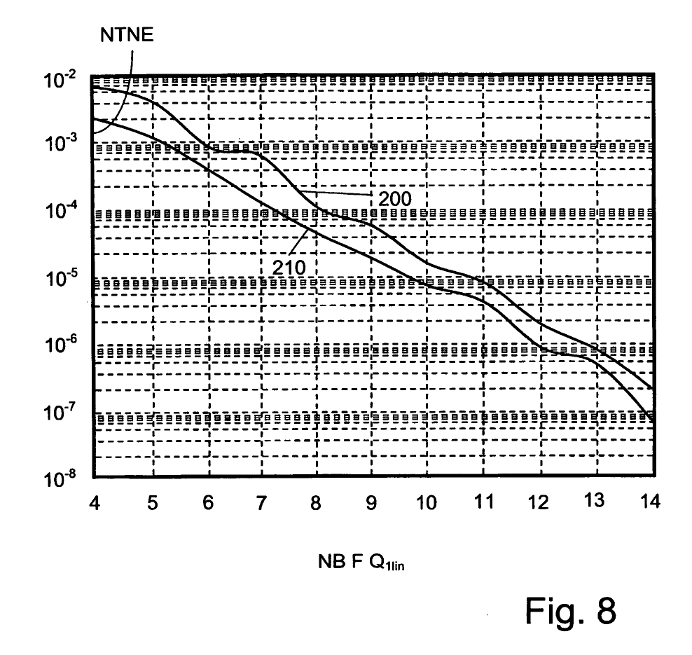

Preferably, in the method, at least one of the first and second quantizing means is arranged to including logarithmic signal quantizing means. A comparison of FIGS. 6 and 8 illustrate very clearly that the invention is capable of providing especially effective noise reduction when logarithmic quantization is employed in comparison to linear quantization.

Preferably, in the method, the first quantizing means is arranged to operate at a higher bit rate than the second quantizing means. Such an operating arrangement is capable of providing enhanced system performance by reducing system noise arising from tandem coding.

Preferably, in the method, at least one of the first and second quantizing means is replaced with a multimedia signal encoding unit. More preferably, the multimedia signal is an audio signal and the encoding unit is an audio encoder. Alternatively, the multimedia signal is a video signal and the encoding unit is a video encoder.

Preferably, in the method, at least one of the first and second quantizing means are arranged in operation to have quantizing characteristics which are dynamically changeable in response to the nature of the input signal to the first quantizing means.

Preferably, in the method, the input signal and the output signal are of mutually different format. Such different format is of advantage in that the system is capable of translating programme content data from one format to another. More preferably, the method is such that the system is operable to convert between contemporary MP3 and AAC signal formats and vice versa.

According to a second aspect of the invention, there is provided a system for executing bit stream processing in tandem coding, wherein the system comprises a series of stages including first quantizing means for processing an input signal to generate an intermediate signal, and second quantizing means for processing the intermediate signal to generate a processed output signal, and wherein the first quantizing means is arranged to include means for predicting distortions arising in subsequent stages of the system and generating one or more corresponding quantization noise reduction parameters , and wherein the system is operable to apply the one or more reduction parameters in at least one of the subsequent stages for reducing noise and/or distortion arising therein.

Preferably, the system includes combining means for embedding a watermarking signal into the intermediate signal so that the processed output signal is a watermarked output signal.

It will be appreciated that features of the invention are susceptible to being combined in any combination without departing from the scope of the invention.

### DESCRIPTION OF THE DIAGRAMS

Embodiments of the invention will now be described, by way of example only, with reference to the following diagrams wherein:

FIG. 1 is a schematic diagram of signal processing stages implemented in a known contemporary watermarking apparatus;

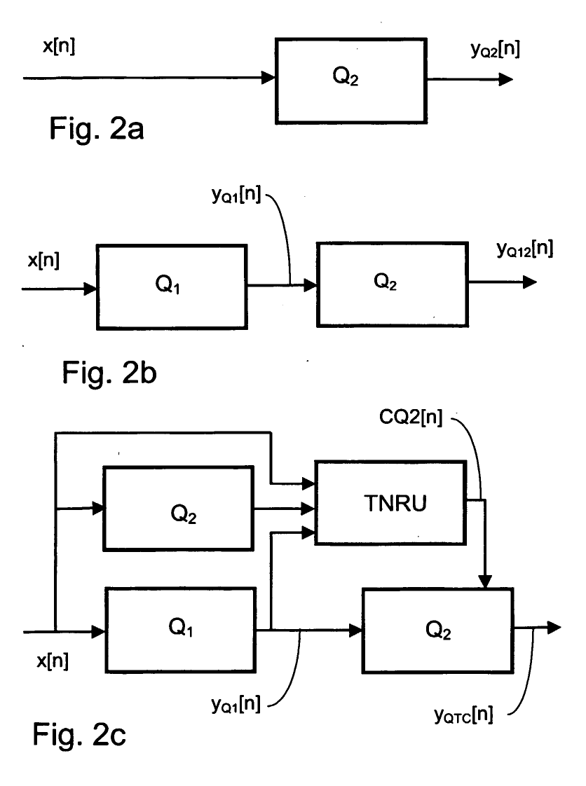

FIGS. 2a, 2b, 2c are illustrations of quantizer configurations for comparing effects of tandem coding;

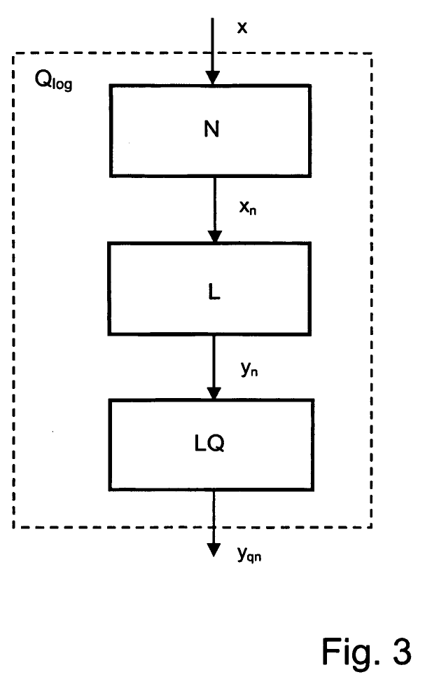

FIG. 3 is a schematic diagram of a simple logarithmic quantizer, Q_{log};

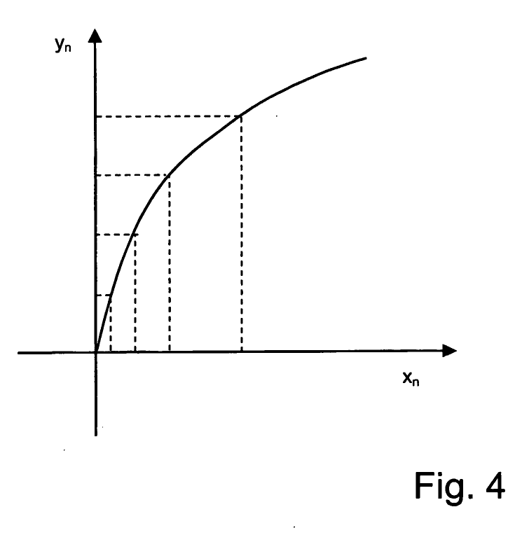

FIG. 4 is a graph representing a logarithmic transformation L;

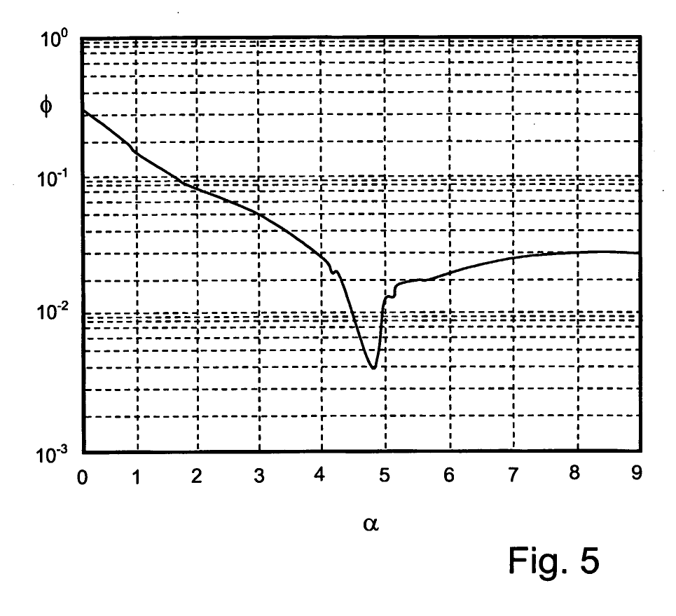

FIG. 5 is a graph representing a typical behaviour of a tandem noise reduction (TNR) cost function;

FIG. 6 is a graph depicting tandem noise energy for two cascaded quantizers Q_{1log}, Q_{2log} for situations of with tandem noise encoding and without tandem noise encoding;

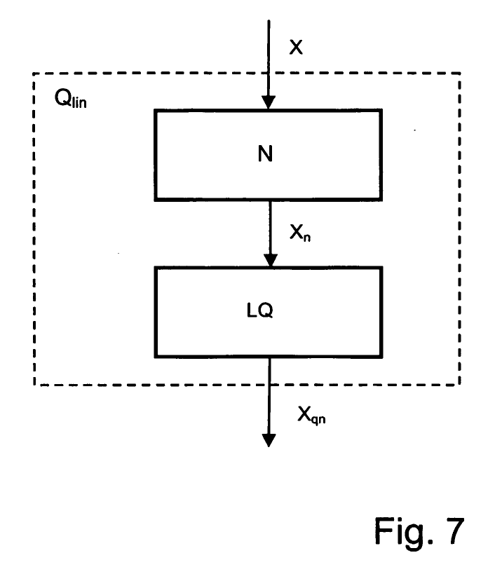

FIG. 7 is a schematic diagram of a simple linear quantizer Qₗᵢₙ;

FIG. 8 is a graph of energy of tandem noise for two cascaded linear quantizers Q₁ₗᵢₙ, Q₂ₗᵢₙ for situations of with and without tandem noise coding; and

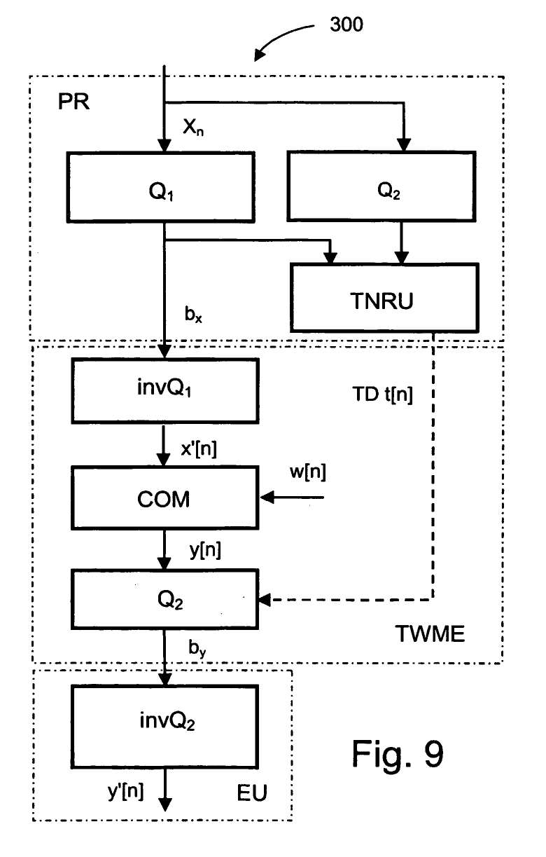

FIG. 9 is a schematic diagram of a generic embodiment of the invention.

### DESCRIPTION OF EMBODIMENTS OF THE INVENTION

In the following description, a brief analysis of quantization error is provided after which embodiments of the invention are elucidated.

It is known that quantization error arising from quantizing a signal x[n] is susceptible to being modelled in a statistical manner if the signal x[n] is sufficiently “complex” and a quantization step S associated with quantization is sufficiently small; in other words, modelling can be beneficially applied as the correlation between the signal x[n] and the quantization error decreases. For two linear quantizers Q₁, Q₂ arranged in a tandem configuration and having corresponding quantization steps Δ₁, Δ₂ respectively, a quantization 5 noise e[n] of each of the quantizers is in range as provided in Equation 1 (Eq. 1):

$$\frac{- Δ}{2} < e [ n ] < \frac{Δ}{2} \qquad Eq . 1$$

where Δ is a quantization step size.

For small steps Δ, the noise e[n] can be assumed to be a random variable which is uniformly distributed over its interval, has a mean of zero and a variance as provided in Equation 2 (Eq. 2) based on an analysis of Oppenheim and Schafer 1989, “Discrete-Time Signal Processing”, published in Prentice Hall Signal Processing Series, ISBN 0-13-754920-2:

$${σ}_{e}^{2} = \frac{{Δ}^{2}}{12} \qquad Eq . 2$$

For a quantizer operable to provide a resolution of (B+1) bits and arranged to provide a full-scale dynamic range Xₘ (i.e., Xₘ=2^{B}Δ), a variance of noise is given by Equation 3 (Eq. 3):

$${σ}_{e}^{2} = \frac{{2}^{- 2 B} {X}_{m}^{2}}{12} \qquad Eq . 3$$

From Equation 3, the noise generated by a tandem series of two cascaded independent quantizers Q₁, Q₂ having a mutually identical quantization step A and a dynamic range Xₘ is given by Equation 4 (Eq. 4):

$${σ}_{e ( 1 , 2 )}^{2} = 2 \cdot \frac{{2}^{- 2 B} {X}_{m}^{2}}{12} = \frac{{2}^{- 2 B + 1} {X}_{m}^{2}}{12} \qquad Eq . 4$$

The noise described by Equation 4 is also capable of being expressed as a signal-to-noise ratio SNR in dB as provided by Equation 5 (Eq. 5):

$$SNR = 10 {log}_{10} ( \frac{{σ}_{x}^{2}}{{σ}_{w}^{2}} ) = 6.02 + 7.79 - 20 {log}_{10} ( \frac{{X}_{m}}{{σ}_{x}} ) \qquad Eq . 5$$

The signal-to-noise ratio determined from Equation 5 for the two quantizers Q₁, Q₂ is approximately 3 dB more noisy, wherein 3 dB=10log₁₀(2), in comparison to only one quantizer, for example solely the quantizer Q₂. The present invention is susceptible to improving the SNR provided by a tandem configuration of two quantizers Q₁, Q₂, namely enhancing the SNR by up to 3 dB.

In describing embodiments of the present invention, it is assumed that there is provided a transcoding configuration including the two quantizers Q₁, Q₂ which are not mutually identical. The invention exploits a characteristic that the a priori knowledge of the characteristics of the quantizer Q₂ in the pre-coding stage (PR) can be used to generate noise reduction parameters that can assist the second quantizer Q₂ to reduce tandem quantization noise (TQN) arising therein; such tandem quantization noise will be elucidated in more detail later.

TQN will now be described in more detail with reference to FIG. 2.

In FIG. 2a, there is shown a quantizer Q₂ arranged to receive an input signal x[n] and generate a corresponding quantized signal y_{Q2}[n]. A configuration presented in FIG. 2a resembles the quantizer Q₂ in the embedding stage TWME illustrated in FIG. 1.

In FIG. 2b, there is included two quantizers Q₁, Q₂ coupled in series, namely in tandem, for processing an input signal x[n] presented to the quantizer Q₁ to generate an intermediate signal y_{Q1}[n] which is further processed in the quantizer Q₂ to generate an output signal y_{Q12}[n]. The quantizer Qi in FIG. 2b resembles the quantizer Q₁ in the pre-coding stage (PR) in FIG. 1. The output signal y_{Q12}[n] in FIG. 2b is quantized twice and therefore subject to a degraded SNR in comparison to FIG. 2a where only a single quantization process is invoked. The present invention is susceptible to improving the SNR for the configuration of FIG. 2b to approach that of the configuration of FIG. 2a, especially in a context of watermarking information being applied. However, the present invention is more broadly applicable to tandem configuration and not limited to watermarking systems.

In FIG. 2c, there is illustrated an embodiment of the invention. There is shown a configuration wherein an input signal x[n] is coupled to inputs of first quantizers Q₁, Q₂ and also to an input of a tandem noise reduction unit (TNRU). Outputs of the first quantizers Q₁, Q₂ are coupled to additional inputs of the TNRU, for example an output y_{Q1}[n] of the first quantizer Q₁ is coupled to the TNRU and also to an input of a second quantizer Q₂. An output control signal CQ2[n] generated in operation by the TNRU is coupled to a further input of the second quantizer Q₂ which is operable to process the signals y_{Q1}[n] and CQ2[n] to generate a quantized output signal Y_{QTC}[n]. In operation, the TNRU is used to estimate the control signal CQ2[n] for the second quantizer Q₂ in such a manner as to reduce the total quantization noise in the output signal y_{QTC}[n]. The embodiment of the invention illustrated in overview in FIG. 2c is capable of being implemented using at least one of linear quantizers and logarithmic quantizers. For more fully elucidating the present invention, such types of quantizers will now be described in further detail.

In FIG. 3, there is shown a logarithmic converter Q_{log}. The logarithmic converter Q_{log} comprises a normalization unit (N), a logarithmic transform unit (L), and a linear quantizer (LQ) coupled in series as illustrated. The normalization unit N is arranged to receive an input signal x[n] and provide a corresponding normalized output signal xₙ. Moreover, the transform unit L is arranged to receive the normalized signal xₙ and provide a corresponding transformed signal yₙ. Furthermore, the quantizer LQ is arranged to receive the transformed signal yₙ and generate a corresponding quantized signal y_{qn}.

In a similar manner to the foregoing wherein a tandem series coupling of two quantizers was considered, such a coupling of two logarithmic converters of a type as illustrated in FIG. 3 is also of relevance to the present invention. By way of example, consider two such logarithmic converters Q_{1log} and Q_{2log} described by a transform shown in Equation 6 (Eq. 6):

$${y}_{n} = \frac{log ( 1 + {Kx}_{n} )}{log ( K + 1 )} \qquad Eq . 6$$

where K is a positive large number; for example, K=30 for the quantizer Q_{1log} and K=30.1 for the quantizer Q_{2log}. A qualitative graphical presentation of Equation 6 is provided in FIG. 4 in which Yₙ is plotted against xₙ.

An additional constraint can be applied to the two quantizers Q_{1log}, Q_{2log} namely that these two quantizers have resolutions of w₁, w₂ bits respectively according to Equation 7 (Eq. 7):
w₁=2w₂ Eq. 7

Thus, in an embodiment of the invention, the quantizers Q_{1log}, Q_{2log} are 8-bit and 4-bit quantizers respectively. However, other word lengths and ratios for w₁, w₂ are feasible.

The quantizers Q_{1log}, Q_{2log} are susceptible to being employed in configurations as depicted in FIG. 2a, 2b, 2c. For example, the quantizers Q_{1log}, Q_{2log} can be used for the embodiment of the invention as depicted in FIG. 2c. Thus, by such substitution, the two logarithmic quantizers Q_{1log}, Q_{2log} are coupled in tandem, namely in series, without TNRU noise reduction whereas the quantizers Q_{1log}, Q_{2log} are coupled with YNRU noise reduction in FIG. 2c.

Data for use in noise reduction in the configuration depicted in FIG. 2c, namely data for producing the signal CQ2[n], is generated by utilizing an offset function g(q) where q is one or more arguments, to reduce a difference between the signals y_{Q2}[n] and y_{Q2}[n] in a least squares sense according to Equation 8 (Eq. 8):

$$ϕ ( α ) = {\sum }_{n}^{} {( {y}_{Q 2} [ n ] - {Q}_{2 log} \{ {y}_{Q 1} [ n ] + g ( α , {y}_{Q 1} [ n ] ) \} )}^{2} \qquad Eq . 8$$

where Q_{2log}{x} is employed to denote the quantizer Q_{2log} applied to the signal x. Preferably, the offset function g{q} is selected to be according to Equation 9 (Eq. 9):
g(α,y_{Q1})=2^{-α}y_{Q1} Eq. 9

Determination of a minimum value for Equation 8 for a condition w₁=8 bits is depicted in FIG. 5; a value generated by Equation 8 and as illustrated in FIG. 5 is also known as a “cost function”.

It is also feasible to determine variances σ₁₂ and σ_{TNRC} of tandem noise signals for the configuration of FIG. 2c where minimization of the aforementioned cost function is implemented for achieving noise reduction as depicted in FIG. 6; a curve 100 corresponds to no TNR correction, whereas a curve 110 corresponds to TNR correction applied. Along an abscissa axis in FIG. 6 is marked number of bits for the quantizer Q_{1log} (NB F Q_{1log}) and along an ordinate axis is normalized tandem noise energy (NTNE). It will be appreciated from FIG. 6 that use of TNR correction as depicted in FIG. 2c is effective at reducing noise energy. In FIG. 6, the variances σ₁₂ and σ_{TNRC} of the resulting tandem noise signals are determinable form Equations 9 and 10 (Eq. 9 and 10):

$$\begin{matrix}{σ}_{12} = {\sum }_{n}^{} {( {y}_{q 12} [ n ] - {y}_{q 2} [ n ] )}^{2} & Eq . 9 \\ {σ}_{TNRC} = {\sum }_{n}^{} {( {y}_{q TC} [ n ] - {y}_{q 2} [ n ] )}^{2} & Eq . 10\end{matrix}$$

It will be further appreciated that TNR is also susceptible to being applied in the configuration of FIG. 2c when linear quantizers are employed therein. A linear quantizer Qₗᵢₙ is depicted in FIG. 7 and comprises a normalizing unit (N) coupled in series with a linear quantizing unit (LQ). In FIG. 7, the linear quantizer Qₗᵢₙ is arranged to receive a signal X and normalize this signal X to generate a corresponding normalized signal Xₙ. Subsequently, the normalized signal Xₙ is quantized in the quantizing unit (LQ) to generate a corresponding normalized quantized signal X_{qn}. The quantizer Qₗᵢₙ of FIG. 7 is capable of being incorporated into the configuration of FIG. 2c with a constraint of Equation 7 applied. As before, an offset function is used for a least squares minimization to determine best operating conditions, the offset function for the linear quantizer Qₗᵢₙ as defined in Equation 11 (Eq. 11):
g(α,y_{Q1})=g(α)=2^{-α} Eq. 11

Variances σ₁₂ and σ_{TNRC} of tandem noise signals for the configuration of FIG. 2c where minimization of the aforementioned cost function are as provided by Equations 12 and 13 (Eq. 12, 13):

$$\begin{matrix}{σ}_{12} = {\sum }_{n}^{} {( {y}_{q 12} [ n ] - {y}_{q 2} [ n ] )}^{2} & Eq . 12 \\ {σ}_{TNRC} = {\sum }_{n}^{} {( {y}_{q TC} [ n ] - {y}_{q 2} [ n ] )}^{2} & Eq . 13\end{matrix}$$

In FIG. 8, there is presented a graph of normalized tandem noise energy (NTNE) against number of bits resolution for the initial quantizer Q₁ₗᵢₙ in the configuration of FIG. 2c. A curve 200 in FIG. 8 corresponds to a tandem configuration without tandem noise reduction (TNR) whereas a curve 210 concerns the tandem configuration of FIG. 2c with TNR. It will be appreciated from FIG. 8 that TNR applied to the configuration of FIG. 2c using linear quantizers is also capable of yielding noise reduction; however, the benefits are not as great as FIG. 6 for logarithmic quantizers.

The configuration of FIG. 2c including TNR is susceptible to being incorporated into the watermarking apparatus depicted in FIG. 1 to yield an embodiment of the invention illustrated schematically in FIG. 9, namely a watermarking apparatus indicated generally by 300. The apparatus 300 includes a pre-coding section (PR) and a transcoding watermark embedding section (TWME). The apparatus 300 is operable to receive an input signal x[n] and to apply a watermark signal w[n] thereto whilst also encoding the watermarked input signal x[n] to generate a corresponding encoded watermarked signal by. An end user (EU) is capable of receiving the signal by, for example conveyed by way of a communication network and/or a data carrier such as at least one of an optical disc ROM, a magnetic hard disc and a solid state electronic memory device. The end user (EU) is capable of decoding the signal by to generate a final decoded signal y′[n] for consumption by the user. In the apparatus 300, quantizers employed therein, for example the quantizers Q₁, Q₂ and their corresponding inverse functions invQ₁, invQ₂, can be either of logarithmic or linear type as described in the foregoing. The apparatus 300 is preferably optimized using the aforesaid cost function to provide an enhanced degree of noise reduction. In the apparatus 300, the input signal x[n] is coupled to inputs of first quantizers Q₁, Q₂. An output bₓ of the first quantizer Q₁ is coupled to an input of the tandem noise reduction unit (TNRU) and also to an input of a decoding function invQ₁. Moreover, a quantized output of the first quantizer Q₂ is coupled to another input of the TNRU. The decoding function invQ₁ is operable to at least partially decode the signal bₓ to generate an intermediate signal x′[n] which is merged with a watermark signal w[n] in a signal combiner (COM) to generate a corresponding intermediate watermarked signal y[n]. The watermarked signal y[n] is received at a second quantizer Q₂ which, under control of a tandem data signal t[n] generated by the TNRU, generates the encoded watermark signal b_{y}.

In operation, the TNRU codes a measure of the difference between the two first quantizers Q₁, Q₂ and transmits tandem data t[n] to the second quantizer Q₂, where in one preferred case the measure of the difference is the difference itself. In a modified version of the apparatus 300, the watermark signal w[n] is embedded in both the tandem data t[n] and the intermediate signal x′[n]. In a yet further modified version of the apparatus 300, the tandem data signal y[n] is digitized in the TNRU and appropriately combined with the signal bₓ.

Other alternative embodiments of the invention are possible. For example, the two quantizers in FIG. 2 can be replaced with audio or video coding units having the same or different coding formats or bit-rates; the pre-coding section PR and the watermarking section TWME may be constructed with a set of possible quantizers such that parameters of the input signal x[n] are used for selecting an appropriate quantizer from the set to employ at any given instance; in other words, the apparatus 300 can be provided with quantizers whose characteristics are dynamically alterable in response to characteristics of the input signal x[n], thereby providing enhanced watermarking and/or improved noise reduction. Preferably, the pre-coder PR then does not need to encode a difference between the two first encoders Q₁, Q₂ but can simple provide a pointer to a subsequent quantizer at a secondary stages in the apparatus 300 corresponding to the first quantizers Q₁, Q₂. The pointer is beneficially employed in the TWME.

The inventors have envisaged that the present invention also relates to bit-stream watermarking apparatus of a form generally similar to the apparatus 300 but where the bit-stream signal bₓ only needs to be transcoded into a different bit rate without a need to embed watermark information. In such an apparatus, the watermarking COM stage is absent so that y[n]=x′[n].

Other embodiments of the invention are possible. For example, the apparatus 300 can be adapted to utilize different bit-rates at its pre-coding PR stage and its embedding stage TWME. The transcoding in the TWME stage can be implemented for bit-rate reduction. Alternatively, the transcoding in the TWME stage can be arranged for processing in an at least partially decoded domain, for example for at least one of watermarking, image enhancement such as colour reinforcement, image detail edge enhancement and so forth. As a further option, transcoding performed in the TWME stage can be for purpose of changing bit-stream format, for example from proprietary AAC format to MP3 format. These alternative adaptations of the apparatus 300 can be implemented in any combination.

As a yet further option, identical bit-rates can be employed in pre-coding PR and transcoding TWME stages of the apparatus 300. Such similar bit-rates are relevant for processing at least partially decoded signals, for example as in watermarking and/or transcoding for changing bit-stream format, for example from AAC to MP3 standards.

The invention is of benefit in that additional noise arising due to quantization in tandem configurations can be potentially reduced. Such noise reduction can also be used as an approach to reduce numbers of bits required to represent a signal whilst maintaining a given level of quantization noise.

The present invention is especially pertinent to electronic music delivery (EMD) systems where digital data content corresponding to items of music, for example popular songs, downloaded from a communication network such as the Internet is stored in a compressed format, for example in one or more of AAC or OCS formats, in a database, for example in a user's music collection stored on a hard disc drive memory. In generating such an item of music, an original music signal has been subject to a first quantizer, equivalent to the first quantizer Q₁ in the apparatus 300, to generate first compressed quantized data, equivalent to the signal bₓ maintained by a music provider. When a purchaser pays the provider for a copy of the quantized data corresponding to the item, the provider at least partially decompresses the desired quantized data, then watermarks the at least partially decompressed desired data and then again compresses the now watermarked desired data. The latter compression is equivalent to the second quantizer Q₂ in the apparatus 300. To preserve quality at the provider site, for example at a data server linked to the Internet, the first quantizer Q₁ thereat is usually arranged to have a higher resolution, namely higher bit-rate and/or finer quantization, than the second quantizer Q₂. In such a scenario, the invention is applicable to exploit insight that the provider has knowledge of the quantizer Q₂ and thus has knowledge of the desired output level y_{Q2}, see Equation 8 in the foregoing. This knowledge can be used for implemented tandem noise reduction (TNR) according to the invention as described in the foregoing, for example to generate a scale factor and/or offset by which the intermediate level y_{Q1} is modified such that the second quantizer Q₂ produces a desired level y_{Q2} instead of y_{Q12}.

It will be appreciated that embodiments of the invention described in the foregoing are susceptible to being modified without departing from the scope of the invention as defined by the accompanying claims.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed to be a reference to the plural and vice versa.

1. A method of bit stream processing in a tandem coding system (300), the method including steps of:
(a) arranging for the system (300) to comprise a series of stages including first quantizing means for processing an input signal to generate an intermediate signal, and second quantizing means for processing the intermediate signal to generate a processed output signal;
(b) arranging for the first quantizing means to include means for predicting distortions arising in subsequent stages of the system and generating one or more corresponding quantization noise reduction parameters; and
(c) applying said one or more noise reduction parameters in at least one of the subsequent stages for reducing noise and/or distortion arising within the system (300).

2. A method according to claim 1, wherein said one or more noise reduction parameters are derived using a cost function applicable to determine when overall quantization noise is minimized.

3. A method according to claim 1, wherein the system (300) includes combining means arranged to embed a watermarking signal into the intermediate signal so that the processed output signal is a watermarked output signal.

4. A method according to claim 3, the method further comprising a step of arranging for the first quantizing means to derive one or more parameters for controlling the combining means for reducing quantization noise arising thereat in operation.

5. A method according to claim 4, wherein the one or more parameters are derived using a cost function applicable to determine when overall quantization noise is minimized.

6. A method according to claim 4, wherein the combining means is arranged to at least partially decode the first intermediate signal and then embed the watermarking signal therein.

7. A method according to claim 1, wherein at least one of said one or more noise reduction parameters corresponds to a transcoding quantization error determined from a difference between:
(a) quantization noise arising in the second quantizing means; and
(b) a difference in quantization noise generated by a tandem combination of the first and second quantizing means.

8. A method according to claim 1, wherein at least one of the first and second quantizing means is arranged to including logarithmic signal quantizing means.

9. A method according to claim 1, wherein the first quantizing means is arranged to operate at a higher bit rate than the second quantizing means.

10. A method according to claim 1, wherein at least one of the first and second quantizing means are arranged in operation to have quantizing characteristics which are dynamically changeable in response to the nature of the input signal to the first quantizing means.

11. A method according to claim 1, wherein at least one of the first and second quantizing means is replaced with a multimedia signal encoding unit.

12. A method according to claim 11, wherein said multimedia signal is an audio signal and said encoding unit is an audio encoder.

13. A method according to claim 11, wherein said multimedia signal is a video signal and said encoding unit is a video encoder.

14. A method according to claim 11, wherein the input signal and the output signal are of mutually different format.

15. A method according to claim 14, wherein the system (300) is operable to convert between MP3 and AAC signal formats and vice-versa.

16. A system (300) for executing bit stream processing in tandem coding, wherein the system comprises a series of stages including first quantizing means for processing an input signal to generate an intermediate signal, and second quantizing means for processing the intermediate signal to generate a processed output signal, and wherein the first quantizing means is arranged to include means for predicting distortions arising in subsequent stages of the system and generating one or more corresponding quantization noise reduction parameters, and wherein the system (300) is operable to apply the one or more reduction parameters in at least one of the subsequent stages for reducing noise and/or distortion arising therein.

17. A system (300) according to claim 16, including combining means for embedding a watermarking signal into the intermediate signal so that the processed output signal is a watermarked output signal.
